(19) United States
(12) Patent Application Publication
(10) Pub. No.: US 2025/0117793 A1
(43) Pub. Date: Apr. 10, 2025

(54) SYSTEMS AND METHODS FOR VALIDATING CLIENT ACCOUNT DATA

(71) Applicant: The PNC Financial Services Group, Inc., Pittsburgh, PA (US)

(72) Inventors: Stephen Christopher BYERS, Pittsburgh, PA (US); Howard Neil FORMAN, Fort Lauderdale, FL (US); Janice Lynne GILL, Baton Rouge, LA (US); Robert Kirk MAY, McMurray, PA (US); Regis John SCHRANZ, Pittsburgh, PA (US)

(73) Assignee: The PNC Financial Services Group, Inc., Pittsburgh, PA (US)

(21) Appl. No.: 18/982,273

(22) Filed: Dec. 16, 2024

Related U.S. Application Data
(63) Continuation of application No. 18/527,083, filed on Dec. 1, 2023.
(60) Provisional application No. 63/385,749, filed on Dec. 1, 2022.
(60) Provisional application No. 63/386,467, filed on Dec. 7, 2022.

(51) Int. Cl. G06Q 20/40; G06F 9/451

(52) U.S. Cl. CPC G06Q 20/40; G06Q 20/108; G06Q 20/42; G06Q 40/02

(57) ABSTRACT

A system and method for validating target account data based on inputs from a user. The system may include a memory storing instructions, and a processor configured to execute the instructions to perform operations. The operations may include providing an interface; receiving a first input; receiving a second input; enabling selection of an activatable element; conducting a lookup associated with the received inputs; receiving a result of the lookup; transforming the result of the lookup into a transformed result that predicts the probability of verification; and displaying transformed result to demonstrate the validity of the received inputs.

### PRIORITY CLAIM

This application claims the benefit of priority of U.S. Provisional Patent Application No. 63/385,749, filed on Dec. 1, 2022; and U.S. Provisional Patent Application No. 63/386,467, filed on Dec. 7, 2022, both of which are incorporated herein by reference in their entirety.

### TECHNICAL FIELD

The disclosed embodiments relate to systems and methods for preemptively validating customer data, more particularly, providing customers with validation as to the target account of an attempted transaction prior to completion of the transaction.

### BACKGROUND

Financial service providers are rapidly expanding the use of mobile services, mobile applications, and web-based software. Currently, most financial service providers provide mobile and digital banking services which allow customers to perform basic functions and transactions remotely, for example, by using an application on a mobile device such as a cell phone or a tablet having an online web interface. Mobile and digital banking allows customers to manage their money without visiting a physical brick and mortar branch bank location. Customers may check account balances, pay bills, transfer funds, send money to others, deposit checks, receive customer support, apply for loans, receive alerts, apply for credit cards, manage benefits, manage credit/debit cards, review transactions, open new accounts, and perform many other banking services on a mobile or digital banking application on a mobile device or computer without travelling to a physical location. The financial services providers provide these functions to customers electronically via an application without the need for in-person teller services.

While these banking functions are useful for enabling funds to be electronically transferred without the need for paper checks or teller support, they fail to provide adequate confirmation that the target account of a transfer is the customer's desired target account. Improved systems and methods for validating a target account are needed. In particular, what is needed is a banking application that receives various inputs from a customer regarding the identity of an intended account of a financial transaction, the banking application subsequently comparing said inputs to a variety of databases and returning an output to the user as to the validity of the input information based on the information retrieved from the variety of databases.

### SUMMARY

Disclosed embodiments provide improved computer systems that validate target recipient accounts before completing an electronic transfer. Some disclosed embodiments involve a banking application that receives various inputs from a customer regarding the identity of an intended account of a financial transaction, the banking application subsequently comparing said inputs to a variety of databases and returning an output to the user as to the validity of the input information based on the information retrieved from the variety of databases.

Disclosed embodiments may include a system for validating target account data, the system including at least one processor configured to: access a platform that enables payment initiation; receive a first input associated with target account data; receive a second input associated with target account data; upon receipt of the first input and the second input, enable selection of an activatable element; in response to selection of the activatable element, perform a lookup associated with the first input and the second input, to validate the first input and the second input; receive a result of the lookup; transform the result of the lookup using machine learning into a transformed result; and present the transformed result.

Disclosed embodiments may include a system for validating target account data, the system comprising: at least one processor configured to: access a platform that enables payment initiation; receive a first input associated with target account data; receive a second input associated with target account data; upon receipt of the first input and the second input, enable selection of an activatable element; in response to selection of the activatable element, perform a lookup in a repository, to validate the first input and the second input, wherein the repository is a national shared database repository; and present a result of the lookup.

Disclosed embodiments may include a system for validating target account data, the system comprising: at least one processor configured to: access a platform that enables payment initiation; receive a first input associated with target account data; receive a second input associated with target account data; upon receipt of the first input and the second input, enable selection of an activatable element; in response to selection of the activatable element, perform a first lookup in a first repository, to validate the first input and the second input; upon performance of the first lookup, perform a second lookup in a second repository, to validate the first input and the second input; and present a result of the first lookup and the second lookup.

Disclosed embodiments may include a system for validating target account data, the system comprising: at least one processor configured to: access a platform that enables payment initiation; receive a first input associated with target account data; receive a second input associated with target account data; enable selection of an activatable element; in response to selection of the activatable element, perform a lookup associated with the first input and the second input, to validate the first input and the second input; present a result of the lookup; and cause a display of a tooltip, wherein the tooltip provides data associated with the result.

Disclosed embodiments may include a system for validating target account data, the system comprising: at least one processor configured to: access a platform that enables payment initiation; receive a first input associated with target account data; receive a second input associated with target account data; enable selection of an activatable element; in response to selection of the activatable element, perform a lookup associated with the first input and the second input, to validate the first input and the second input; present a result of the lookup, wherein the result includes a caution; and upon presentation of the result, cause the presentation of a pop-up window on a user device.

Disclosed embodiments may include a system for validating target account data, the system comprising: at least one processor configured to: access a platform that enables payment initiation; receive a first input associated with target account data; receive a second input associated with target account data; enable selection of an activatable element; in response to selection of the activatable element, perform a lookup associated with the first input and the second input, to validate the first input and the second input; present a result of the lookup, wherein the result includes a no-result; and upon presentation of the result, cause the presentation of a pop-up window on a user device.

Disclosed embodiments may include a system for validating target account data, the system comprising: at least one processor configured to: access a platform that enables repetitive payment initiations; receive a first input associated with target account data; receive a second input associated with target account data; upon receipt of the first input and the second input, automatically perform a lookup in a repository, to validate the first input and the second input; and present a result of the lookup.

### BRIEF DESCRIPTION OF THE DRAWINGS

The accompanying drawings, which are incorporated in and constitute a part of this specification, illustrate disclosed embodiments and serve to explain the disclosed embodiments. In the drawings:

FIG. 1a is an illustration of a situation involving a user desiring to ensure the target account is their desired target account prior to completion of a financial transaction;

FIG. 1b is an illustration of a situation involving a user's satisfactory experience satisfied with an account validation system that ensures the target account is their desired target account prior to completion of a financial transaction, consistent with some disclosed embodiments;

FIG. 2 is a block diagram of an exemplary system environment, consistent with some disclosed embodiments;

FIG. 3 is a block diagram of a server, consistent with some disclosed embodiments;

FIG. 4 is an exemplary embodiment of a verification system components, consistent with some disclosed embodiments;

FIG. 5 illustrates an exemplary graphical user interface (GUI) for validating a target account of a financial transaction, consistent with some disclosed embodiments;

FIGS. 6-8 illustrate exemplary graphical user interfaces displaying various results of a lookup returned from some disclosed embodiments;

FIG. 9 illustrates an exemplary graphical user interface displaying a tooltip, consistent with some disclosed embodiments; and

FIG. 10 is an exemplary flowchart of a validation process, consistent with some disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

Reference will now be made in detail to the disclosed embodiments, examples of which are illustrated in the accompanying drawings.

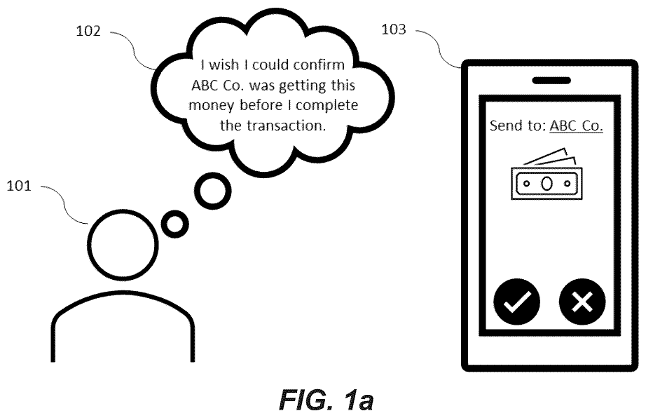

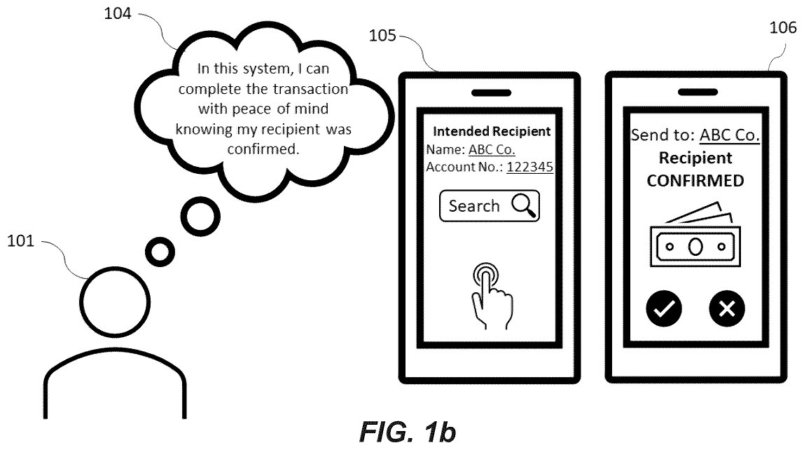

FIG. 1a is an illustration of a situation involving a user 101 expressing a desire 102 to ensure their target account of a financial transaction completed on a web-based application 103 is their intended target account. In this current situation, the web-based application 103 merely accepts some input from the user 101. The user 101 then can only choose to complete or refuse to complete the financial transaction displayed on the web-based application 103. The user 101 has no way of confirming the identity of their target account prior to completing the financial transaction in the web-based application 103.

FIG. 1b is an illustration of a situation involving the user 101 expressing a satisfied experience 104 based on a web-based application prompt 105 requesting information from the user 101 about their desired target account and a web-based application prompt 106 confirming that the user 101 is completing their financial transaction to their desired target account. Unlike the web-based application described in FIG. 1a, the web-based application prompt 104 in FIG. 1b enables the user 101 to provide multiple inputs to conduct a lookup for the user 101 to validate their target account. Then, the web-based application prompt 106 replaces web-based application prompt 105. Web-based application prompt 106 may be similar to web-based application 103 (see FIG. 1a), except that web-based application prompt 106 includes a confirmation that the target account of the financial transaction is the desired target account of the user 101.

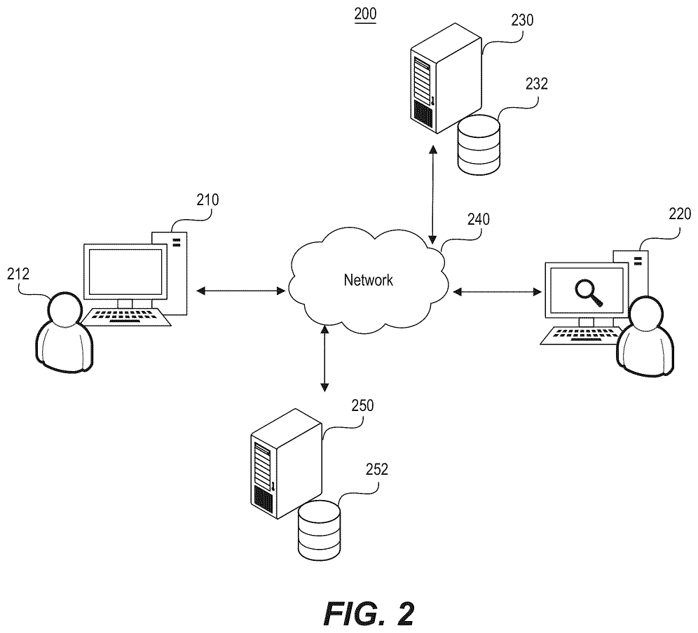

FIG. 2 illustrates an example system environment 200 for validating target account data, consistent with disclosed embodiments. System environment 200 may include one or more endpoint devices 210 and 220, and one or more servers 230 and 250. System environment 200 may represent a system or network environment in which payment initiations of a user 212 on a financial institution endpoint device 210 are validated. For example, server 230 may maintain and provide a database 232 via network 240. Network 240 may, for example, be a privileged network that requires an authorization to access. For example, only authorized devices may access the data stored on database 232 via network 140. For example, in FIG. 2, server 250, may be a financial institution server. Server 250 may provide a user interface to an endpoint device 210, via network 240. Server 250 may receive and process data from database 232 and provide a result of the processing to an endpoint device 210. Additionally, for example, server 250 may provide an application programming interface (API) to a third-party endpoint device 220. Server 250 may receive and process data from database 232 and provide a result of the processing to an endpoint device 220.

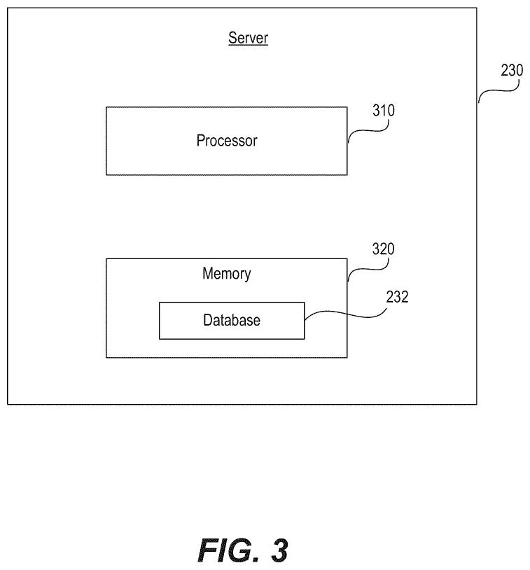

Additionally, FIG. 3 illustrates a server 230 (see FIG. 2), a processor 310, and a memory 320 that utilizes a database 232. The database 232 can either be a publicly accessible database or an independently owned and maintained database. The memory 320 may be configured to store one or more software programs that perform several functions when executed by the processor 310.

In some embodiments, a user could send a request to the server 230. This request could be any identifying information about a target account such as a target account name and a target account address. The server 230 would then transmit the request to the processor 310, which compares that request to the information found in the memory 320. This information found in the memory 320 can include memory stored in a database 232. Then, the processor 310 builds a response to transmit back to the server 230 for the user to view. The server 230 provides all information necessary to the network 240 (see FIG. 2).

Aspects of this disclosure may relate to a system for validating target account data. Validating, as used herein, may include confirming, comparing, evaluating, proving, reviewing, authenticating, certifying, corroborating, or otherwise verifying data. A target may be any client, customer, person, individual, payee, buyer, seller, company, party, organization, emailer, fraudster, beneficiary, or other entity. For example, a target may be a company requesting payment. Alternatively, a target may be an entity making a payment. For example, a target may be an intended beneficiary. Account data may include any input, data, response, contribution, record, fact, detail, name, number, or other information. Target account data may include any address, pin, number, account, identifier, data, name, address, information, or other account data relating to a target. In some embodiments, validating target account data may refer to verifying an entity's target account data. For example, in response to a target account's request for payment, validating target account data may refer to comparing the target account's information with data stored in a repository and determining that the target account's information matches the information stored in a repository.

Disclosed embodiments may involve at least one processor, such as processor 310 of FIG. 3. A processor may be any physical device or group of devices having electric circuitry that performs a logic operation on an input or inputs. For example, the at least one processor may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller or may be stored in a separate memory.

Disclosed embodiments may include accessing a platform that enables payment initiation. Accessing may refer to opening, going to, or otherwise obtaining authorization, entry, permission, access, or admission to receive data and information from a platform. Accessing a platform may include gaining access to functionality, such as software, or otherwise retrieving information that enables access to a platform, generating a platform, viewing a platform, or being provided a platform. For example, accessing a platform may involve logging into an account requiring a username and password. Additionally, or alternatively, accessing a platform may include going to a website or a webpage. A platform may include any application, API, location, product, document, operating system, network, instrumentality, or other program accessible through an electronic medium. In some embodiments, a website or webpage may be an example of a platform. For example, a platform may be an online banking platform. Additionally, or alternatively, a platform may be any application accessible on a device (e.g., a computer, laptop, smartphone, tablet, VR headset, smart watch, or any other electronic display device). Enables may include allows, permits, supports, aids, grants, or otherwise facilitates. A payment may include any compensation, fee, money, amount, expense, disbursement, discharge, deposit, remittance, premium, order, benefit, transfer, or other transaction. For example, a payment may be a freeform domestic payment, such as a book transfer, wire transfer, or Real-Time Payments (RTP). Payment may also be in the form of one-time payments or reoccurring payments. Payment initiation may refer to any action or process that originates, starts, begins, initiates, enters, finalizes, creates, derives, enables, or otherwise makes a payment. For example, accessing a platform that enables a payment initiation may include logging onto an online banking platform.

Disclosed embodiments may include receiving a first input associated with target account data and receiving a second input associated with target account data. The relational terms herein such as “first” and “second” are used only to differentiate an input or operation from another input or operation, and do not require or imply any actual relationship or sequence between these inputs or operations. Receiving an input may include receiving a manual or automatic data input via a computing device. For example, receiving an input may include a computing device associated with a user manually entering data, instructions, or other information into a dialog box. An input may include a user action or something that is provided, given, or transmitted to a computing device. In some embodiments, an input may be a command or signal from a user, such as typing in credentials or other account data into a dialog box provided by a platform. In some embodiments, an input may be made by typing data into a box provided by a platform. Additionally, or alternatively, an input may be made by a selection from a dropdown box. For example, receiving an input associated with target account data, may include typing an account number into a cell of a platform. Additionally, or alternatively, receiving an input associated with target account data, may include entering a company name into a dialog box provided by a platform.

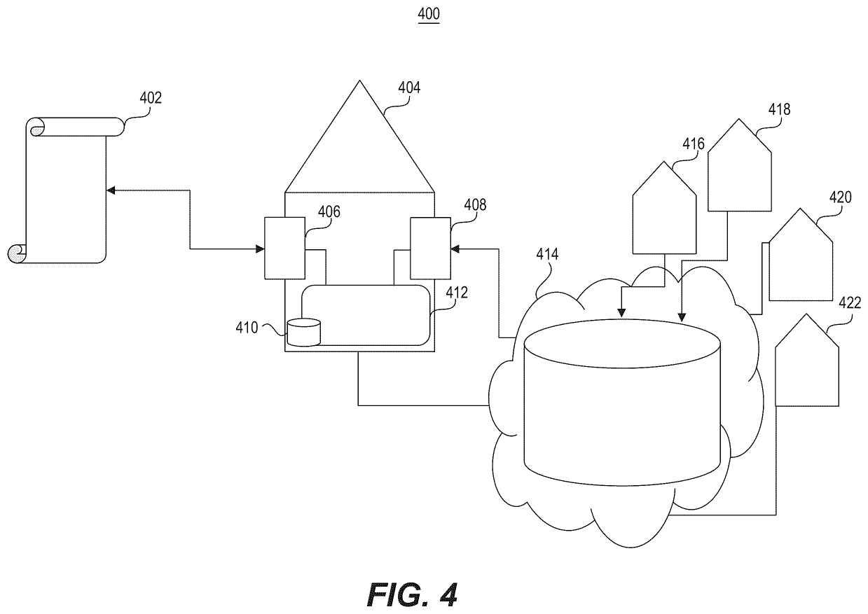

For example, FIG. 4 illustrates an exemplary display of a platform 400 that enables payment initiation. Platform 400 may display a user interface provided by Server 250 (see, e.g., FIG. 2). A user may enter a first input into a first dialog box 404 (“Account” in FIG. 4) displayed on platform 400. Similarly, a user may enter a second input into a second dialog box 406 (“Name” in FIG. 4) displayed on platform 400.

Disclosed embodiments may include, upon receipt of the first input and the second input, enabling selection of an activatable element. A selection may be any action to choose, click, designate, elect, or otherwise pick an activatable element. For example, a selection may be a mouse click, a user input, a typing, a mouseover, a hover, a touch on a touch sensitive surface, a keystroke, a movement in a virtual interface, or any other action indicating an election of an activatable element. For example, a selection may be made by a mouse click of a button within a platform. Alternatively, a selection may be made by using keystrokes to initiate a command. An activatable element may include any element of a platform which may be interacted with through a mouse cursor, a touchable area (as on a touchscreen or touchpad), eye movement (such as with eye trackers), a gesture (such as may be detected by a camera), an application program interface (API) that receives a keyboard input, or any hardware or software component that may receive user inputs, or other means of activation. For example, an activatable element may include a button that is selected by a user with a mouse click. Additionally, or alternatively, an activatable element may include selecting the enter button on a keyboard. For example, upon receipt of the first input and the second input, enabling selection of an activatable element may refer to allowing a user to click a button labeled “validate” after entering target account information into an online banking platform.

For example, in FIG. 4, a button 408 (“validate” in FIG. 4) may represent an activatable element. Button 408 may not appear until a user enters a first input into dialog box 404 and a second input into dialog box 406, via endpoint device 210 (see e.g., FIG. 2). Similarly, or alternatively, button 408 may appear, but may not be enabled until after a first input in dialog box 404 and a second input in dialog box 406 are entered.

Disclosed embodiments may include, in response to selection of the activatable element, performing a lookup associated with the first input in dialog box 406 and the second input in dialog box 408, to validate the first input and the second input. Performing a lookup may include any indexing, processing, or any other operation for searching a repository for data or information. A lookup may include a search, inquiry, rifle, analysis, assessment, evaluation, index, inspection, or other review of data. A lookup may be done in a preset repository or in a database of dynamic data. In some embodiments, performing a lookup associated with the first input and the second input may refer to comparing the data of first input and the second input with the date stored in a repository. To validate may mean to confirm, check, verify, prove, compare, assess, match, certify, substantiate, correlate, associate, authenticate or otherwise corroborate. In some embodiments, to validate the first input and the second input may refer to comparing the first input and the second input to data stored in a repository. For example, to validate the first input and the second input, the at least one processor may index a repository for data that matches the data associated with the first input and the second input. Additionally, or alternatively, to validate the first input and the second input, the at least one processor may search data and determine that the input data does not match the searched data. In some embodiments, performing a lookup may include a processor using fuzzy logic (i.e., the concept of a partial truth where a truth value may range from completely true to completely false) to determine if input data matches data stored in a repository. For example, a processor may perform a lookup and validate the first input, “Bob,” and second input, “ABC Corp.,” even when the indexed repository only contains data for “Robert” and “ABC Corporation.” For example, the fuzzy logic may categorize the information as “close or exact matches,” “conditional or partial matches,” “no matches,” or “no identifying data available” to permit greater flexibility in accepting user inputs. In some embodiments, the processor may use fuzzy logic when performing a lookup for only one of the inputs. Alternatively, the processor may use fuzzy logic when performing a lookup for both inputs. Additionally or alternatively, the processor may use Boolean logic to perform a lookup.

For example, in FIG. 2, a user 212 may access a platform via endpoint device 210 provided by Server 250. The platform may be, for example, platform 400. For example, in FIG. 4, a user may enter a first input into dialog box 404 and a second input into dialog box 406. After entering the first input and the second input, a user may, using a mouse, click button 408 and, in response to the click, a processor may search a repository for information that matches the information entered into dialog box 404 and dialog box 406.

Disclosed embodiments may include, in response to selection of the activatable element, performing a lookup in a repository, to validate the first input and the second input, wherein the repository is a national shared database repository. A repository may include a data repository, storage, data source, collection of data, memory, data structure, or any other source of data or information. In some embodiments, a repository may be an online database. Alternatively, a repository may be data stored locally on a computing device. For example, a repository may be a collection of target account data. In some embodiments, a repository may refer to a data source contributed to by financial institutions that regularly contribute their account and transaction information to the data source. Alternatively, a repository may refer to a private collection of target account data contributed to by a select number of banks. Performing a lookup in a repository, as described above, may include any indexing, processing, or any other operation for searching a repository for data or information. A national shared database repository may be any public, private, communal, common, connected, or otherwise accessible repository of data and information. A national shared database repository may contain data or information regarding consumer and business accounts. Alternatively, a national shared database repository may only contain data regarding business accounts. For example, a national shared database repository may refer to the National Shared Database Resource, to which financial institutions regularly contribute their trusted account and transaction information.

Disclosed embodiments may include, in response to selection of the activatable element, perform a first lookup in a first repository, to validate the first input and the second input; upon performance of the first lookup, perform a second lookup in a second repository, to validate the first input and the second input. The relational terms herein such as “first” and “second” are used only to differentiate a lookup or operation from another lookup or operation, and do not require or imply any actual relationship or sequence between these lookups or operations. As discussed above, performing a lookup in a first repository may include any indexing, processing, or any other operation for searching a repository for data or information. In some disclosed embodiments, a processor may perform a lookup in a first data repository for corroborating data, and then also perform a lookup in a second, different repository for corroborating data. For example, the processor may automatically perform a lookup in more than one repository. Alternatively, the processor may only perform a lookup in more than one repository if the first repository provides a no result and does not provide any matching data. Additionally, or alternatively, the processor may perform a lookup in more than one repository and present a result based on the data found in all the repositories searched. For example, the result may be the same in two repositories. Alternatively, the result may be different from each of the two repositories and the processor may present a result indicating the discrepancy.

In some embodiments, the result may be a transformed result based on the result received from one or multiple repositories. Such transformed results may be a prediction as to the probability that the target account is the intended target account. The system may utilize artificial intelligence or machine learning to improve the accuracy of such transformed results. Such artificial intelligence or machine learning algorithms may receive the resulting outputs from the database 232 in response to several user inputs, compare the resulting accuracy of each input with each received result, and return to the user a single output. For example, a user may input the target account's first name, last name, and address. The processor 310 may determine that the first and last names are close or exact matches to the information stored in the database 232, but the address does not match the information stored in the database 232. The artificial intelligence or machine learning algorithms may transform those results into a single overall score that cautions the user that the address input did not match the address stored in the database 232. Alternatively, the artificial intelligence or machine learning algorithm may instead transform those results into a single overall score that informs the user that the target account authentication passed.

For example. in FIG. 4, a verification system 400 receives initial inputs from a user in a payment portal 402 on an interface 406 controlled by a bank 404. These initial inputs can be any identifying information about a target account such as a target account name and a target account address. These inputs are then transferred to a server 412. The sever 412 may contain processing logic. The server 412 may transmit the inputs to a verification database 414 Additionally or alternatively, the server 412 may access a database 410 which is controlled by the bank 404. According to this embodiment. the verification database 414 is a national shared database repository managed by multiple financial service providers 416, 418, 420, and 422. The verification database 414 subsequently provides its account information to the bank 404 through an interface 408. This account information is transmitted to the server 412. The server 412 may compare the input information received from the interface 406 with the account information received from interface 408 and database 410. The server 412 may utilize artificial intelligence or machine learning algorithms to create an output to return to the user based on how closely the information received from the interface 406 matches the information retrieved from database 410 in addition to or in alternative to the information received from interface 408. The server 412 may then transmit its final result to interface 406 to present on payment portal 402 for the user to perceive.

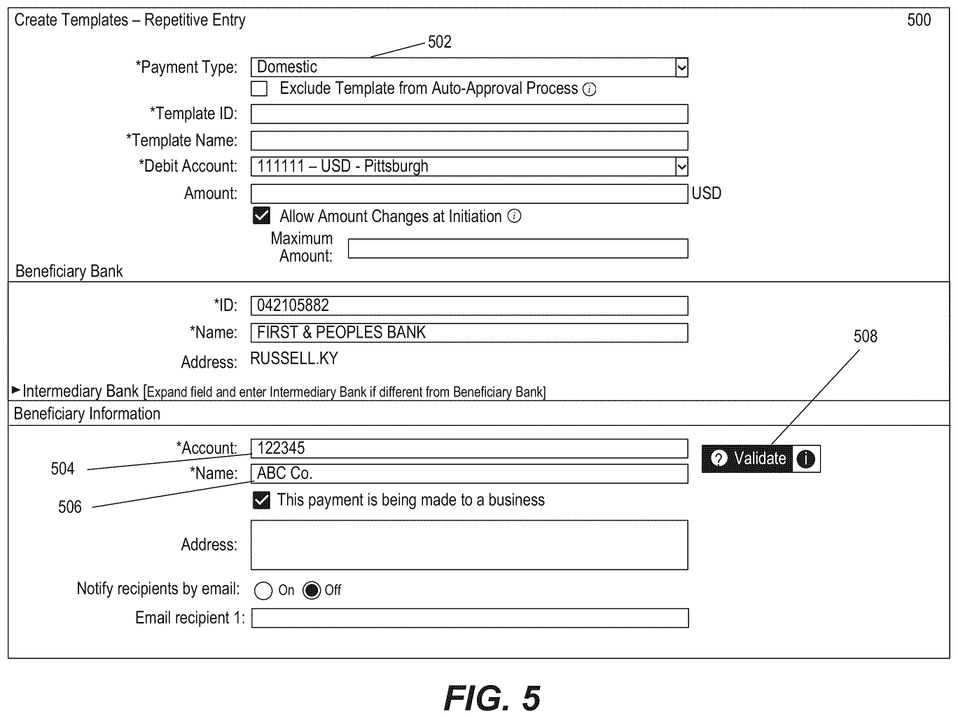

The payment portal 402 on interface 406 may be a web-based application. For example, FIG. 5 illustrates an exemplary display of a platform 500 that enables payment initiation. In FIG. 5, a user may enter a payment input in a payment box 502, a first input into dialog box 504, and a second input into dialog box 506. A user may click a button 508 and, in response to the click, a processor may search a first repository for information that matches the information entered into dialog box 504 and dialog box 506. Once a first repository is searched, a processor may search a second repository for information that matches the information entered into dialog box 504 and dialog box 506. Based on how closely the information stored in the first repository and the second repository match the information entered into dialog box 504 and dialog box 506, the result of the lookup may be an indication of validation, caution, or no match.

Disclosed embodiments may include presenting a result of the lookup. Presenting a result may include any rendering, representation, aid, demonstration, showing, or other display of a result. In some embodiments, presenting a result may include causing a display of information associated with a result. A result may include any information, message, notification, product, answer, outcome, indication, assessment, effect, conclusion, ramification, or other determination associated with a lookup. For example, presenting a result may enable a user to visually understand the outcome of the lookup. In some embodiments, presenting a result may include displaying text on a screen indicating a result.

Disclosed embodiments may include presenting a result of the lookup, wherein the result includes a validation. A validation may include a confirmation, justification, approval, certification, output, answer, or any other authentication. For example, a validation may refer to presenting a result indicating that certain data and information exists in a repository. As discussed above, a validation may be based on fuzzy logic. Alternatively, a validation may involve Boolean logic. In some disclosed embodiments, a processor may return a validation after searching a repository and finding data that matches the input data.

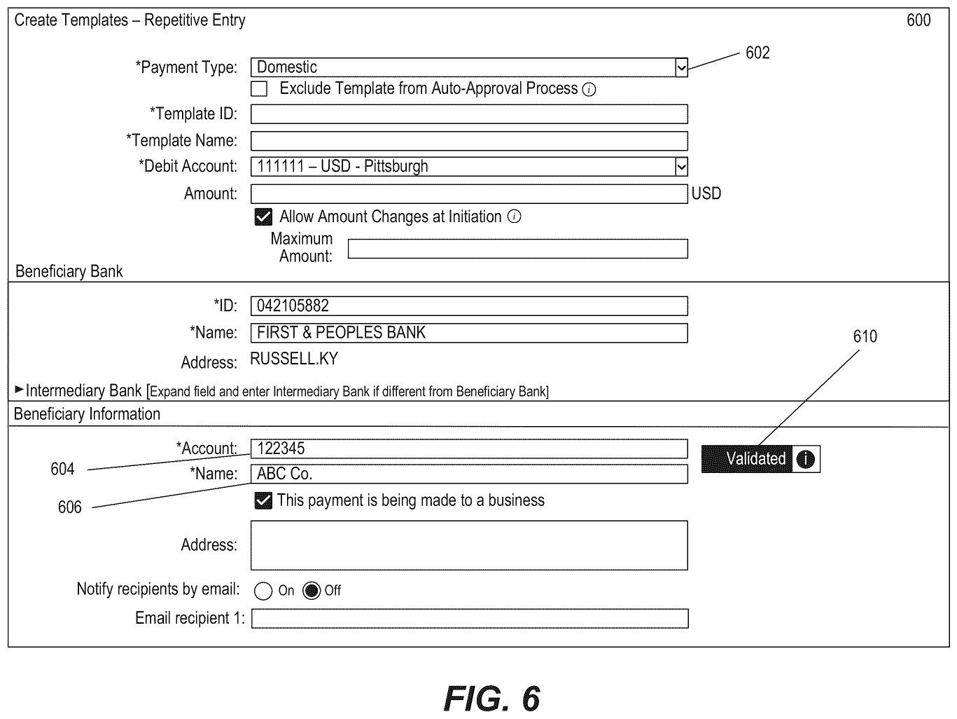

For example, FIG. 6 illustrates an exemplary display of a platform 600 that enables payment initiation. A user may enter a a payment input in a payment box 602, a first input into dialog box 604, and a second input into dialog box 606, and click a button (e.g., button 508 in FIG. 5) initiating a search of a repository for information that matches the information in dialog boxes 604 and 606. Upon confirmation that the information in dialog boxes 604 and 606 matches information contained in a repository, platform 600 may display a validation 610 (“Validated” in FIG. 6).

Disclosed embodiments may include presenting a result of the lookup, wherein the result includes a no-results. A no-result may include an answer, output, caution, or other result that may be futile, fruitless, pointless, or otherwise based on no data. For example, a no result may indicate that data or information was searched for in a repository and no matching data or information was found. In some embodiments, a no result may indicate that a lookup associated with target account data did not find any matching data or information in a repository. Additionally, or alternatively, a no result may indicate that a lookup associated with target account data found only partially matching data in a repository.

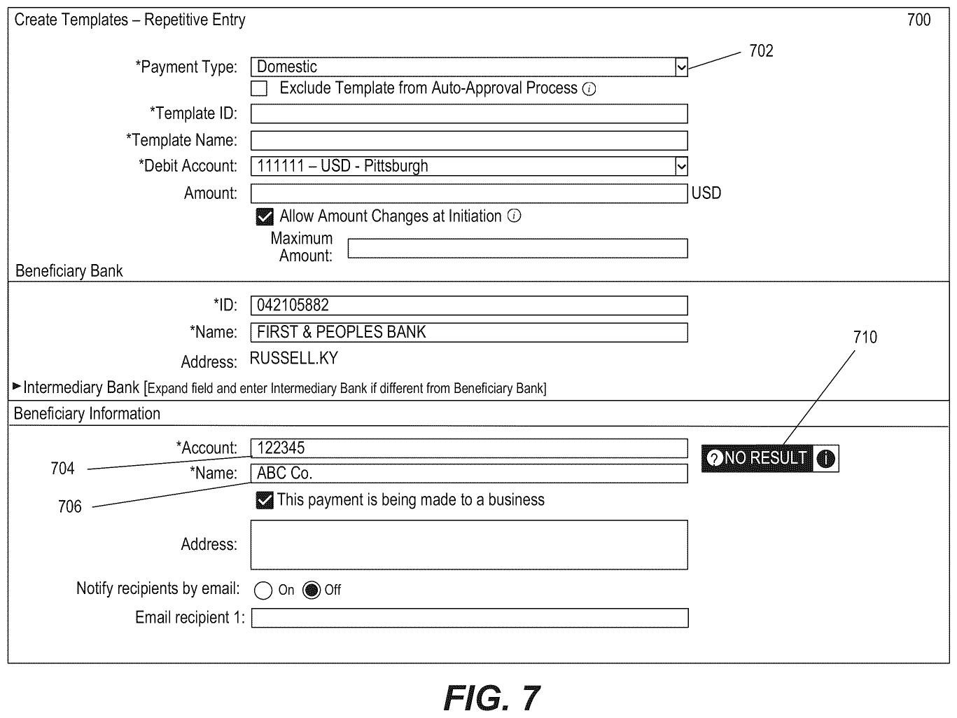

For example, FIG. 7 illustrates an exemplary display of a platform 700 that enables payment initiation. A user may enter a payment input in a payment box 702, a first input into dialog box 704, and a second input into dialog box 706, and click a button (e.g., button 508 in FIG. 5) initiating a search of a repository for information that relates to the information in dialog boxes 704 and 706. After a repository is searched and no information in a repository relates to the information in dialog boxes 704 and 706, platform 700 may display a no-result 710 (“NO RESULT” in FIG. 7).

Disclosed embodiments may include presenting a result of the lookup, wherein the result includes a caution. A caution may be an alert, concern, signal, caveat, no validation, or any other result that indicates a warning. In some embodiments, a caution may refer to a result that indicates data in a repository does not match data searched for in a repository. Additionally, or alternatively, a caution may refer to a result that only some of the data in a repository matches data searched for in the repository.

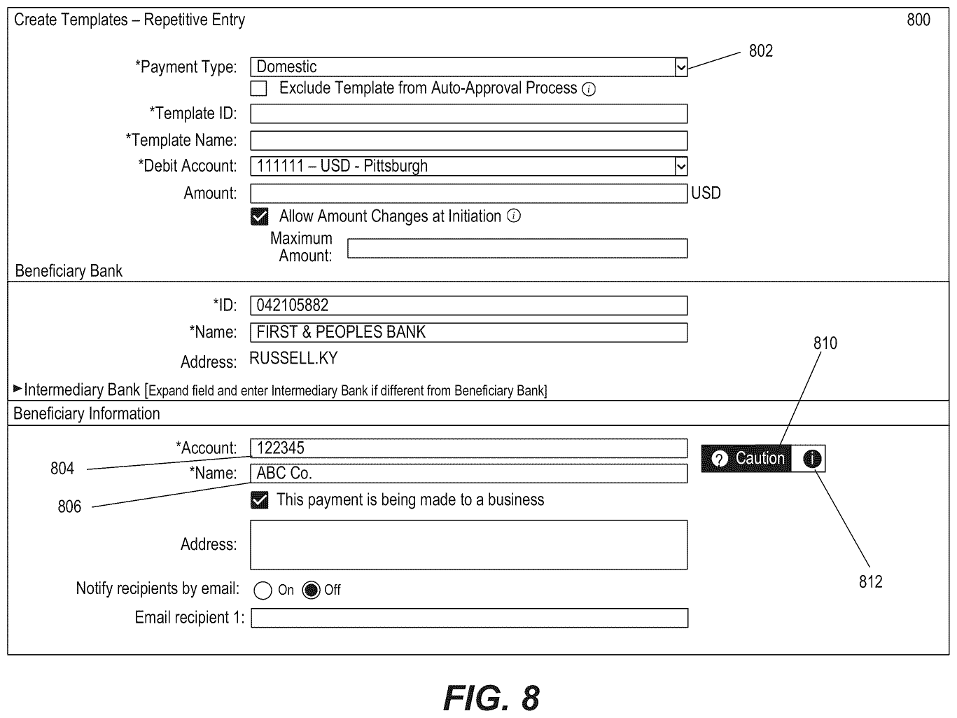

For example, FIG. 8 illustrates an exemplary display of a platform 800 that enables payment initiation. A user may enter a payment input in a payment box 802, a first input into dialog box 804, and a second input into dialog box 806, and click a button (e.g., button 508 in FIG. 5) initiating a search of a repository for information that matches the information in dialog boxes 804 and 806. After a repository is searched and information is found that is contrary to information in dialog boxes 804 and 806, platform 800 may display a caution 810 (“Caution” in FIG. 8).

Disclosed embodiments may include presenting a result of the lookup, wherein the result includes at least one of a validation, a no-result, or a caution. In some embodiments, the result may include a no-result and a caution. Alternatively, as discussed above, the result may include a validation. Additionally, or alternatively, the result may include only a caution. The result may be binary (e.g., validated or not validated). Additionally, or alternatively, the result may provide a level of caution, for example, on a scale between one and ten based on an artificial intelligence or machine learning algorithm. For example, a user may input target account data into a text field of a platform and click a button that causes a processor to lookup target account data in a repository, and upon validating that the repository contains the target account data, present a validation result to the user, confirming the existence of the input data in the repository. Additionally, or alternatively, the processor may lookup target account data in a repository and only find a partial match of the data in the repository and present a caution to the user.

Disclosed embodiments may include causing a display of a tooltip, wherein the tooltip provides data associated with the result. Causing a display may include displaying, revealing, showing, demonstrating, explaining, or otherwise presenting a display. A display may be any visual rendering, representation, aid, pop-up, demonstration, or other presentation of data or information. A tooltip may be any communication, pop-up, information, idea, data, meaning, or other message providing information or otherwise explaining data related to the result. In some embodiments, a tooltip may be a message explaining the result to a user. Tooltips may be generated automatically with the presentation of a result. Alternatively, a tooltip may be displayed when a user interacts with a graphical user interface (GUI). In some embodiments, causing a display of a tooltip, wherein the tooltip provides data associated with the result may include an informative message that appears when, for example, a user hovers a mouse over the result. For example, a tooltip may offer information and context regarding the result. In some embodiments, a tooltip may explain a result via a pop-up text message presented on a user computer. For example, in response to a no result a processor may cause a display of a message encouraging a user to take steps to further confirm target account data (i.e., encouraging a user to call a target account holder on the phone, or meet a target account holder in person, to validate the target account data). Alternatively, in response to a validation result, a processor may cause the display of a message validating the target account data.

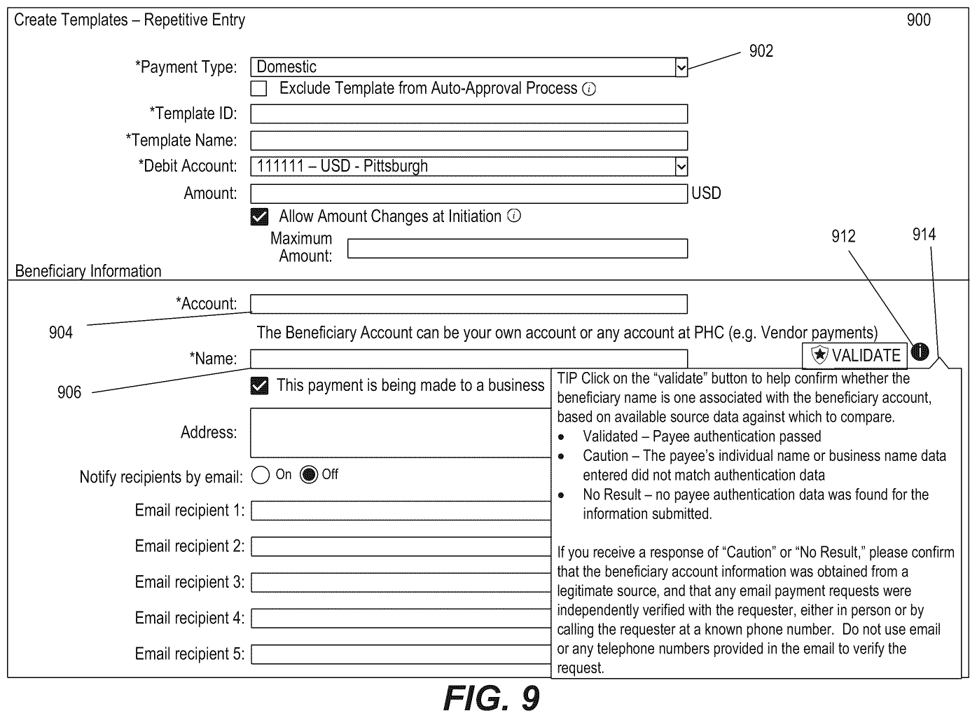

For example, FIG. 9 illustrates an exemplary display of a platform 900 that enables payment initiation. A user may enter a payment input in a payment box 902, a first input in a first dialog box 904, and a second input in a second dialog box 906 A user may hover a mouse over an informational element 912, which may cause a tooltip dialog box 914 to appear. Tooltip dialog box 914 may include instructional information, such as the definition of possible results (e.g., “Validated” 610 in FIG. 6; “NO RESULT” 710 in FIG. 7, and “Caution” 810 in FIG. 8).

Disclosed embodiments may include presenting a result of the lookup, wherein the result is a transformed result based on how closely the data stored in a repository matches the data provided in a first input and a second input, and includes a caution, and upon presentation of the result, causing the presentation of a pop-up window on a user device. Presenting a result of the lookup, wherein the result includes a caution, as discussed above, may include presenting an alert, concern, signal, caveat, no validation, or any other result that indicates a warning. In some embodiments, a processor may determine that some or all of the account data found in a repository does not match the input target account data and may present a caution. Causing the presentation of a pop-up window on a user device may include presenting, introducing, revealing, showing, demonstrating, explaining, or otherwise displaying a pop-up window on a user device. A pop-up window may include any frame, box, interface, dialog window, dialog box, display, or other prompt. In some embodiments, the pop-up window may appear automatically upon a caution result. Additionally, the pop-up window may stay on the user device until a user checks a box or clicks a button to make it disappear. Additionally, or alternatively, the pop-up window may disappear after a set duration of time. A user device may include a computer, laptop, smartphone, tablet, or any other electronic display device capable of receiving and sending data. In some embodiments, upon a caution result, a dialog box cautioning the user of a user device may appear.

Disclosed embodiments may include presenting a result of the lookup, wherein the result includes a no-result; and upon presentation of the result, causing the presentation of a pop-up window on a user device. Presenting a result of the lookup, wherein the result includes a no-result, as discussed above, may include presenting an alert that the result is based on no data. In some embodiment, the processor may not find any data in the repository that matches the target account data input by a user. For example, upon presentation of a no-result, a dialog window explaining that the repository lacked information matching the target account data may appear. The pop-up dialog window may require the user of a user device to check a box confirming additional action has been taken by the user to independently verify the target account data (such as calling the target account holder) before the dialog window may be exited.

Disclosed embodiments may include, upon receipt of the first input and the second input, automatically performing a lookup in a repository, to validate the first input and the second input. Automatically performing a lookup in a repository may include performing a lookup in the repository without a selection from a user. In some embodiments, a processor may perform a lookup in a repository after a second input. For example, a processor may perform a lookup in the repository immediately after target account data is input. Alternatively, a processor may continuously perform a lookup in the repository of data entered in a dialog box associated with target account data. Additionally, or alternatively, a processor may automatically perform a lookup in the repository when a user clicks outside of the dialog box containing target account.

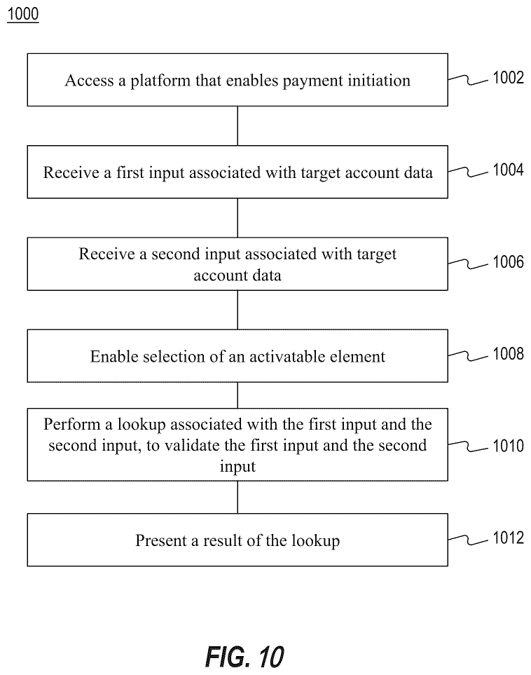

FIG. 10 illustrates an exemplary process 1000 for conducting a target account lookup. At step 1002, a user access of a platform that enables payment initiation. A platform that enables payment initiation may be the platform 500 as described in FIG. 5.

At step 1004, the user enters a first input into the network 240, and at step 1006, the user enters a second input into the network 240. These first and second inputs can be any information capable of identifying a target account and may be entered into a first dialog box and a second dialog box respectively. For example, in FIG. 5, a first input may be the account number of the target account and may be entered in a first dialog box 504, and a second input may be the name of the target account and may be entered in a second dialog box 506. Other information identifying a target account may include the address of the target account, the birthdate of the target account holder, or any other such identifying information.

At step 1008, the network 240 activates an element in response to the two inputs being provided, allowing the user to interact with the element. For example, in FIG. 5, the button 508 may become activated such that a user utilizing the platform 500 may interact with the button 508.

At step 1010, the network 240 performs a lookup associated with the inputs to validate both inputs in response to the user interacting with the element. For example, the network 240 may be a part of the server 412 in FIG. 4 and thus may perform a lookup in an external data repository or an internal repository.

At step 1012, the network 240 presents the results of the lookup conducted in step 1010 for the user to observe. The result of the lookup may be a transformed result to simplify the retrieved data. For example, the result may be a validation 610 such as described in FIG. 6 (“Validated”).

Some systems and methods disclosed herein involve unconventional improvements over conventional approaches. Descriptions of the disclosed embodiments are not exhaustive and are not limited to the precise forms or embodiments disclosed. Modifications and adaptations of the embodiments will be apparent from consideration of the specification and practice of the disclosed embodiments. Additionally, the disclosed embodiments are not limited to the examples discussed herein.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and, accordingly, all suitable modifications and equivalents may be resorted to, falling within the scope of the disclosure.

Computer programs based on the written description and methods of this specification are within the skill of a software developer. The various functions, scripts, programs, or modules may be created using a variety of programming techniques. For example, programs, scripts, functions, program sections or program modules may be designed in or by means of languages, including JAVASCRIPT, C, C++, JAVA, PHP, PYTHON, RUBY, PERL, BASH, or other programming or scripting languages. One or more of such software sections or modules may be integrated into a computer system, non-transitory computer readable media, or existing communications software. The programs, modules, or code may also be implemented or replicated as firmware or circuit logic.

Moreover, while illustrative embodiments have been described herein, the scope may include any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps or inserting or deleting steps. It is intended, therefore, that the specification and examples be considered as exemplary only, with a true scope and spirit being indicated by the following claims and their full scope of equivalents.

1.-14. (canceled)

15. A system for validating target account data, the system comprising:
a memory storing instructions; and
at least one processor configured to execute the stored instructions to:
generate a platform that enables payment initiation on an endpoint device;
access the platform;
generate a tooltip for display on the platform, wherein the tooltip provides information about the platform;
receive, through the endpoint device, a first input associated with target account data;
receive, through the endpoint device, a second input associated with target account data;
upon receipt of the first input and the second input, enable selection of an activatable element;
in response to selection of the activatable element, transmit the first input and the second input to a server;
perform a lookup associated with the first input and the second input in the server;
receive a result of the lookup from the server;
transform the result of the lookup using machine learning into a transformed result, wherein the transformed result includes an indication of caution;
update the tooltip using a machine learning model to generate a caution tooltip, wherein the caution tooltip displays data corresponding to the indication of caution;
present the transformed result on the endpoint device;
present the indication of caution on the endpoint device; and
present the caution tooltip with the indication of caution on the endpoint device.

16. The system of claim 15, wherein:
the lookup further comprises comparing the first input and the second input with data stored in the server; and
the at least one processor is further configured to:
update the caution tooltip to display information on the comparison between the data stored in the server and the first input and the second input; and
present the caution tooltip on the endpoint device.

17. The system of claim 16, wherein the at least one processor is further configured to:
compare the first input and the second input with data stored in the server using fuzzy logic;
update the transformed result based on the comparison;
update the indication of caution based on the comparison; and
update the caution tooltip to display information regarding the updated indication of caution.

18. The system of claim 15, wherein:
the lookup results in a match between data in the server and at least one of the first input and the second input; and
the at least one processor is further configured to:
update the indication of caution based on the match; and
update the caution tooltip to display information regarding the updated indication of caution.

19. The system of claim 15, wherein:
the transformed result includes a validation of at least one of the first input or the second input; and
the at least one processor is further configured to:
update the caution tooltip to display information regarding the validation of the at least one of the first input or the second input and the indication of caution.

20. The system of claim 19, wherein:
the transformed result is presented to indicate the validation of the at least one of the first input or the second input; and
the at least one processor is further configured to:
update the indication of caution based on the validation
update the caution tooltip to display information regarding the updated indication of caution.

21. The system of claim 15, wherein the indication of caution includes a level of caution.

22. The system of claim 21, wherein the at least one processor is further configured to update the caution tooltip to display information about the level of caution.

23. The system of claim 15, wherein the at least one processor is further configured to:
generate a pop-up window on a user device to display the caution tooltip; and
present the caution tooltip on the pop-up window.

24. The system of claim 23, wherein the at least one processor is further configured to automatically generate the pop-up window displaying the caution tooltip in response to transforming the result.

25. The system of claim 20, wherein:
the transformed result includes an indication of a no-results; and
the at least one processor is further configured to:
update the indication of caution based on the indication of no-results; and
update the caution tooltip to display information regarding the updated indication of caution.

26. The system of claim 25, wherein the at least one processor is further configured to update the caution tooltip to suggest options for reviewing at least one of the first input and the second input based on the indication of no-results.

27. The system of claim 15, wherein the lookup results in no matches between the data in the server and one of the first input and the second input.

28. The system of claim 27, wherein:
the transformed result is presented to indicate no matches between the data in the server and one of the first input and the second input; and
the at least one processor is further configured to:
update the indication of caution based on the indication of no matches; and
update the caution tooltip to display information regarding the updated indication of caution.

29. A method comprising:
accessing a platform that enables payment initiation;
generating a tooltip for display on the platform;
receiving a first input associated with target account data;
receiving a second input associated with target account data;
enabling selection of an activatable element;
performing a lookup associated with the first input and the second input, to validate the first input and the second input;
generating a result of the lookup;
generating an indication of caution based on the result of the lookup;
updating the tooltip to display information regarding the indication of caution to generate a caution tooltip;
presenting the result of the lookup on the platform;
presenting the indication of caution on the platform; and
presenting the caution tooltip on the platform.

30. The method of claim 28, further comprising:
transforming the result of the lookup using machine learning into a transformed result;
updating the indication of caution based on the transformed result;
updating the caution tooltip based on the updated indication of caution;
presenting the transformed result on the platform;
presenting the updated indication of caution; and
presenting the caution tooltip on the platform.

31. The method of claim 30, further comprising:
generating a level of caution with the indication of caution; and
updating the caution tooltip to display information regarding the level of caution.

32. The method of claim 31, further comprising:
presenting an indication of validation on the platform;
updating the caution tooltip to display information on the level of caution and the indication of validation; and
present the updated caution tooltip on the platform.

33. The method of claim 31, further comprising:
presenting an indication of no-results on the platform;
updating the caution tooltip to display information on the level of caution and the indication of no-results; and
present the updated caution tooltip on the platform.
